(19) United States
(12) Patent Application Publication
(10) Pub. No.: US 2012/0247474 A1
(43) Pub. Date: Oct. 4, 2012

(54) FACE MASK APPARATUS AND SYSTEM

(76) Inventor: Steve Gordon Torbenson, Burnsville, MN (US)

(21) Appl. No.: 13/433,983

(22) Filed: Mar. 29, 2012

Related U.S. Application Data
(60) Provisional application No. 61/468,774, filed on Mar. 29, 2011.

(51) Int. Cl. A62B 23/02; A62B 18/02; A62B 18/10

(52) U.S. Cl. 128/206.15

(57) ABSTRACT

A mask-type apparatus facilitates air filtration. In accordance with one or more embodiments, a mask includes a shell and a filter coupled to the shell. The shell secures the filter to a user's face, with the filter being between the shell and the user. In some implementations, the filter and shell are secured to one another via a valve that passes air between a user and an environment. With these approaches, the mask-type apparatus readily facilitates replacement of the filter while also providing a secure fitment of the filter to a user's face, for a variety of applications.

### RELATED PATENT DOCUMENTS

This patent document claims benefit under 35 U.S.C. §119 to U.S. Provisional Patent Application Ser. No. 61/468,774, entitled “Neoprene Sport Dust Mask with MP3 Player Holder” and filed on Mar. 29, 2011; this patent document is fully incorporated herein by reference.

### FIELD

Aspects of various embodiments of the present invention are directed to air filtration, and more specifically to face masks for filtering air for breathing.

### BACKGROUND

Many environments present hazardous or uncomfortable breathing conditions. For example, some environments may carry particulates that can be harmful or uncomfortable to breath. Other environments may include chemicals, vapors or other components that can be harmful.

Various face masks have been used in an effort to filter air for a variety of applications. For example, medical masks have been used in hospital type environments to protect the user against inhaling undesirable viruses or micro-organisms. Other masks have been used to filter dirt and other airborne particles. However, many of these face masks can be difficult to implement, deteriorate over time, and fail to provide adequate filtering, particularly when used in different applications.

These and other matters have presented challenges to the implementation of face masks and other filtering applications, for a variety of uses.

### SUMMARY

Various example embodiments are directed to face masks, face mask filters, face mask assemblies, and their implementation.

According to an example embodiment, an apparatus includes a mask shell, a filter and a valve. The shell includes a first material portion having a plurality of openings that pass air through the mask shell, and an opening region via which the valve passes. The shell also includes second and third material portions having a first end connected to opposing sides of the first portion and a second having a fastener that couples the second and third portions. The filter has an opening region aligned to the opening region in the first portion of the mask shell and via which the valve passes. The valve secures the filter to the mask shell at the respective opening regions at which the valve passes air through the mask shell and filter (via the openings).

Another example embodiment is directed to an apparatus having a mask shell, air filter and a fastener. The mask shell passes air and flexibly secures around a user's head to secure the filter directly to the user's face. The air filter restricts most or all (about all) air that passes between the user and an environment such that the air passes via the filter. The fastener includes one or both of a valve and a fastening structure. The valve (when employed) extends through respective opening regions in the mask shell and the air filter, and secures the filter to the mask shell at the respective opening regions. The fastening structure connects the air filter to the mask shell, such as via a snap type connection, with the snap being integrated in the filter or pressing through the filter.

The above discussion/summary is not intended to describe each embodiment or every implementation of the present disclosure. The figures and detailed description that follow also exemplify various embodiments.

### DESCRIPTION OF THE FIGURES

Various example embodiments may be more completely understood in consideration of the following detailed description in connection with the accompanying drawings, in which:

FIGS. 1A and 1B respectively show left and right side views of an air mask, in accordance with an example embodiment of the present invention;

FIG. 2 shows a mask shell and filter assembly, in accordance with another example embodiment of the present invention;

FIG. 3 shows an air valve assembly, in accordance with another example embodiment of the present invention;

FIGS. 4A-4D show another air valve assembly, in accordance with another example embodiment of the present invention;

FIG. 5 shows a water supply apparatus for use with a mask shell and filter assembly, in accordance with another example embodiment of the present invention;

FIG. 6 shows a perspective view of a face mask arrangement, in accordance with another example embodiment of the present invention; and

FIG. 7 shows a side view of another face mask arrangement, in accordance with another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims.

### DETAILED DESCRIPTION

Aspects of the present invention are believed to be applicable to a variety of different types of devices, systems and arrangements involving air filtration and control. While the present invention is not necessarily so limited, various aspects of the invention may be appreciated through a discussion of examples using this context.

Various example embodiments are directed to a facemask having a shell and a filter interchangeably coupled thereto, with the filter and shell having respective conforming coupling portions that operate with a coupling mechanism (e.g., a fastener) that couples to both the filter and shell, and facilitates venting therebetween.

In accordance with a more particular example embodiment, a face mask type apparatus includes an outer shell support structure, configured and arranged for securing to a user's face, and an inner filter coupled to the outer shell support structure. The filter covers from the bridge of the nose and under the jaw and allows for an effective seal to prevent any air reaching the user without penetrating the filter. This also allows for the mask to be worn for extended periods of times while retaining comfort.

The outer shell may include one or more of a variety of materials, to suit particular applications, filter type and/or in accordance with available materials. In some embodiments, the shell structure includes a non-woven material, and/or a material such as neoprene or polychloroprene type of material that maintains flexibility over a broad temperature range and allows for a comfortable fit when placed on a users face. The thickness of the shell structure is tailored for particular implementations, and in some embodiments is a low profile design that fits under helmets and goggles. A closed cell waterproofing-type structure is used for certain applications, to block moisture and retain optimum body temperature. An abrasion-resistant fabric having high durability can be implemented to extend the lifetime of the shell.

In some embodiments, the shell is constructed of two pieces of neoprene sewn together at the ends to form a portion of a mask that wraps/forms around a user's nose and chin. The sewn ends facilitate conformance of the material of the shell about a user's face and chin (e.g. relative to bending a contiguous portion of such material around a user's face). In this context, it has been discovered that such positioning of a joint between the respective sides of the materials, combined with ventilation and filter-shell coupling as discussed herein, can facilitate conformation of the filter/mask combination about a user's face while maintaining comfort with respect to the conformation and ventilation.

In addition, opposite ends of each sewn portion are implemented with a fastener attachment that facilitates an adjustable and comfortable fit around the user's facial area, while also maintaining conformed contact between the filter and the user's face. Such a fastener attachment may, for example, include a hook-and-loop type fastener such as available from Velcro of Manchester, N.H. The shell covers the nose and mouth of its user while fitting around the lower jawbone before attaching at the back of the user's head and upper neck. In addition, the filter is configured to conform with the shell to also cover the nose and mouth of the user, with the shell, to facilitate the filtration of air exchange with the user's mouth and nose.

In certain embodiments, the shell includes a section of mesh netting that facilitates airflow to the user's skin. The mesh may, for example, be located at portions of the shell corresponding to respective corners of the user's lower jaw and cheeks. The front of the mask contains openings (e.g., 26 holes on both sides for a total of 52) that facilitate air circulation and reduce inhaling and exhaling resistance.

Two larger holes in the shell hold and fit two valves that regulate airflow being inhaled and exhaled, and that also couple the shell and filter to one another and relative to a user's face. Above the holes at the very top of the neoprene shell is a metal nosepiece that facilitates an adjustable and confirming fit for different users. The nose piece rests on the bridge of the user's nose and supports the mask on its user. In some implementations, the nose piece is fastened with a female rivet that facilitates coupling to a filter affixed with a male end to snap into place.

In certain embodiments, a small pouch is coupled to the support structure to hold a small media device such as an Mp3 player, or other things such as a pack of matches. This small slip can be made of a common material as the mask (e.g., neoprene) and is located on an outer side of the mask.

The valves that couple the filer to the shell are implemented in different manners to suit particular embodiments. In some embodiments, two plastic, one-way valves are affixed on both sides of the masks. The valves point away from the face and expel exhaled air from the user. The one-way valves limits the entry of inhaled air.

In some implementations, a one-way valve as described herein includes three pieces, including two twist off pieces that are connected by a male and female connector and divided by a thin piece of rubber that regulates the air being inhaled and exhaled. The front of the valve features a directional vent that can be adjusted to control the direction of the inhaled air. These valves help ease resistance of inhalation and exhalation. The valves hold the filter in place by locking the filter through the holes in the filter and shell.

A variety of filters are used to suit particular applications. In some implementations, the filtration layer is rated at N99 and is non-toxic, has little or no smell and exhibits high filtration efficiency and has low breathing resistance. The filter includes a non-woven activated carbon layer containing activated charcoal inside the layers as a particulate. The filter and active carbon is air absorptive and absorbs odors and scents, and can be used to mask the scent of a user's breath. The activated charcoal is efficient at preventing passage of micro-organisms and absorbing pollution.

According to another example embodiment, a mask includes a shell, filter and a valve. A front portion of the mask secures to a user's face, around the user's nose and chin, and rear-extending straps wrap around a user's head to secure the front portion the face and therein also to secure a filter between the front portion and the user's face. The shell and filter both have openings therein via which an air valve extends and secures the filter to the shell. The valve passes air in one or both directions, and can be tailored to the application. For instance, where the valve is used in an environment in which the mask is subjected to fast-moving air that may include particulates, a one-way valve can be used to permit exhalation while inhaled air is passed through a filtering fabric or other material in the filter. The valve thus passes air in one direction, and can mitigate or prevent air from passing around the valve via flanges or other components securing the valve to the mask and filter.

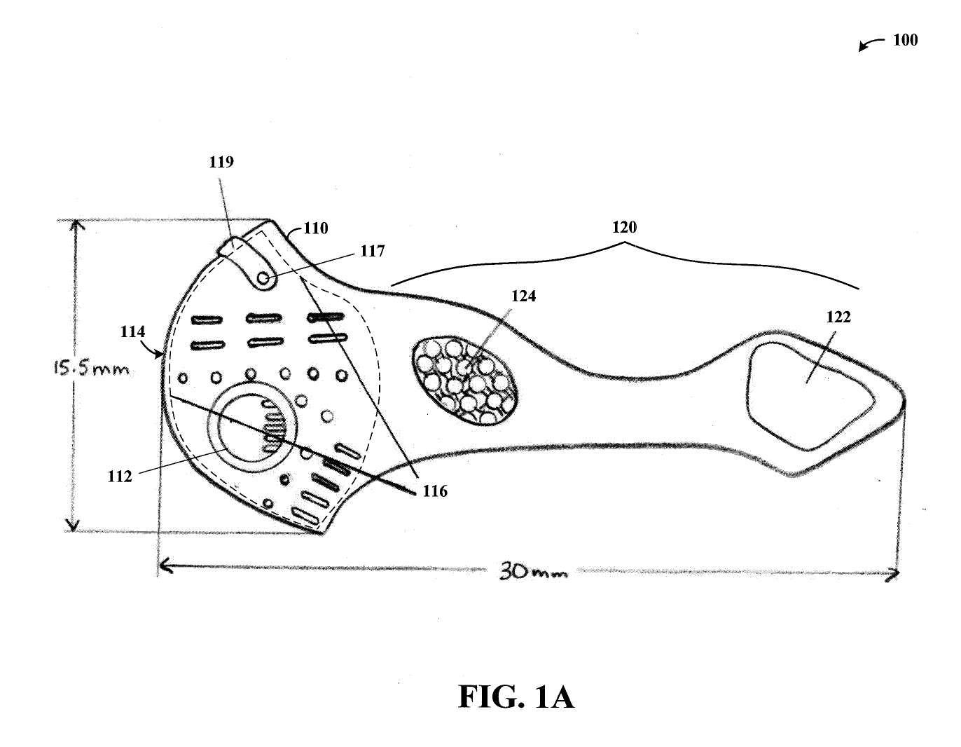

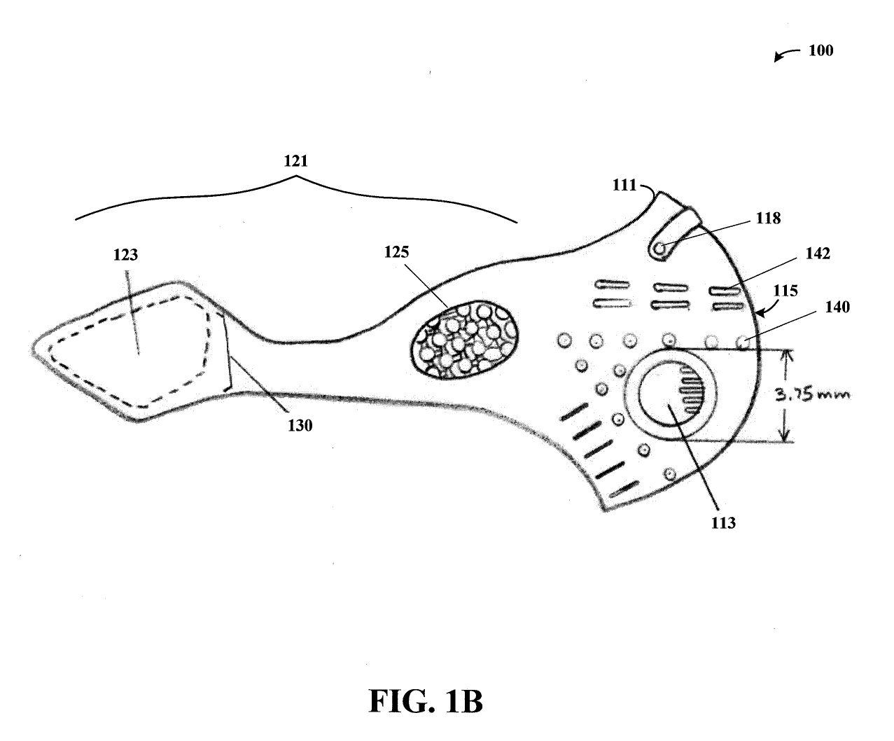

Turning now to the Figures, FIGS. 1A and 1B respectively show left and right side views of an air mask 100, in accordance with an example embodiment of the present invention. Referring to the left-side view in FIG. 1A, the mask includes a front-left portion 110 that conformably fits about a user's nose and chin area at 114, and a strap portion 120 that extends from the front portion. Referring to the right-side view in FIG. 1B, a front-right portion 111 similarly conformably fits about a user's nose and chin area at 115, is coupled with (or part of) the front-left portion 110 at the nose and chin area (at 114 and 115), and includes a similar strap portion 121.

The respective strap portions 120 and 121 wrap behind a user's head and fasten together to apply a holding tension that presses the front-left portion 110 and front-right portion 111 against a user's face. In some implementations, the strap portions 120 and 121 include an elastic material that stretches, and functions to flexibly secure the front-left and front-right portions 110 and 111 to a user's face via the holding tension. While a variety of different types of fasteners can be used, the air mask 100 is shown with a hook-and-loop type fastener 122/123, with fastener portion 122 being located on an outer (front side) portion of the left-side strap 120, and fastener portion 123 being located on an inner (back side) portion of the right-side strap 121. This arrangement can be reversed to suit particular applications (i.e., with fastener portion 122 being located on an inner portion of the left-side strap 120, and fastener portion 123 being located on an outer portion of the right-side strap 121.

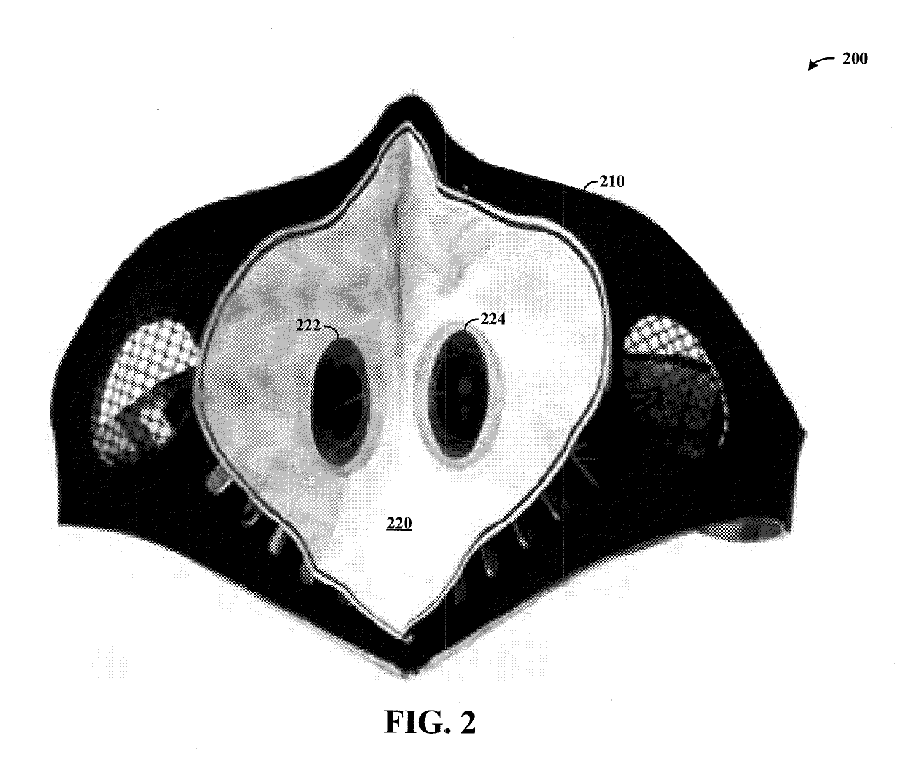

Each of the front-left and front-right portions 110 and 111 have an opening therein with a combined fastener/air valve protruding through the opening and fastening a filter to an inside portion of the mask 100, as represented by dashed lines at 116 in FIG. 1A. By way of example, reference may be made to FIG. 2 as described further below, which shows an inside view of a mask with a filter attached thereto as can be implemented with the mask 100. Referring to FIG. 1A, the opening is shown with a valve 112 in place. Referring to FIG. 1B, the opening is also shown with a valve 113 in place. The filter is a one-piece filter that conforms to an inner surface of the mask 100, and has openings that match those of the front-left and front-right portions 110 and 111.

Each of the respective valves 112 and 113 is configured to extend through the openings in both the mask and the filter, and to lock the filter in place. A variety of different types of valves can be implemented (e.g., one-way, or two-way) to suit different applications, and some of which are described below and illustrated in other figures. In addition, the valves 112 and 113 can lock the filter to the mask shell in a variety of manners, with the valves as shown having flanges with inner and outer portions that sandwich the filter 116 to the front-left and front-right mask portions 110 and 111.

Openings in the mask 100 facilitate the passage of air through the front-left 110 and front-right 111 portions of the shell, to the filter for breathing. Referring to FIG. 1B, round (140) and oblong (142) openings are shown and reveal a filter therein. These openings are placed such that incoming air is readily filtered prior to reaching the user's nose and/or mouth, with the valves 112 and 113 facilitating exhalation of air directly through openings in both the filter shown through openings 140 and 142, and the front-left (110) and front-right (111) mask shell portions. The placement of the valves 112 and 113 can be set to mitigate the passage of dirt and other particulates in the air into the valve (e.g., when a user is moving fast, such as in riding a motorized vehicle) while permitting comfortable exhalation.

The respective left and right sides of the mask 100 may be joined in one of more of a variety of manners. In some implementations, the left and right sides are formed of a continuous material, and conforms around a user's nose and chin. In other implementations, the left and right sides are fastened together at front-left and front-right portions 110 and 111 of the respective mask sides, such as by stitching, welding or gluing, with a resulting seam running along the center of a user's nose and chin when fitted.

The mask 100 may be made of a variety of sizes, and optionally includes various other aspects as shown by way of example in FIGS. 1A and 1B. For instance, the mask 100 is shown as having an exemplary dimension of 15.5 mm in height, and 30 mm in length for each strap, with a valve having a diameter of about 3.75 mm. However, different sizes are implemented to suit different applications. Referring to FIG. 1B, the mask is shown having a pouch-type structure 130, which can be used to house an audio device such as an audio player or a communication device (e.g., for radio and/or cellular communications). In addition, the mask is shown with openings 124 and 125 having a mesh-type structure therein, which can facilitate cooling and/or other comfort. The air-passing openings 140 and 142 as discussed above can also be made with different shapes or sizes, or be implemented with different quantities.

In some embodiments, the mask 100 includes fastening structures at 117 (FIG. 1A) and 118 (FIG. 1B) that secure a rigid nose piece 119 to the mask 100, at front-left and front-right portions 110 and 111. The nose piece 119 may, for example, include a bendable metal type of material that can be bent and conformed to the bridge of a user's nose. In some implementations, the fastening structures 117 and 118 also couple to the filter 116, such as via a snap-in type connection with respective male and female portions (protrusions/cavity) of a snap at the fastening structures and corresponding positions on the filter. Using this approach, the snap-in function can be used without necessarily securing the filter 116 to the mask shell portions 110 and 111. Moreover, such an approach can be implemented with a filter that does not have openings therein where the valves 112 and 113 are shown.

FIG. 2 shows a mask assembly 200 including a supporting shell 210 and filter 220, in accordance with another example embodiment of the present invention. The mask 200 may, for example, be implemented using one or more aspects of the mask 100 shown in FIGS. 1A and 1B. Both the shell 210 and filter 220 have openings therein through which respective valves 222 and 224 extend. The valves 222 and 224 have separable inner and outer portions, which couple to one another via the openings and also affix the filter 220 to the shell 210. The valves 222 and 224 are detachable, such that the filter 220 is readily replaced. For instance, when used in wet and muddy riding conditions for an all-terrain vehicle, the filter 220 may become soiled with mud. The valves 222 and 224 can be detached, allowing removal and replacement of the filter 220.

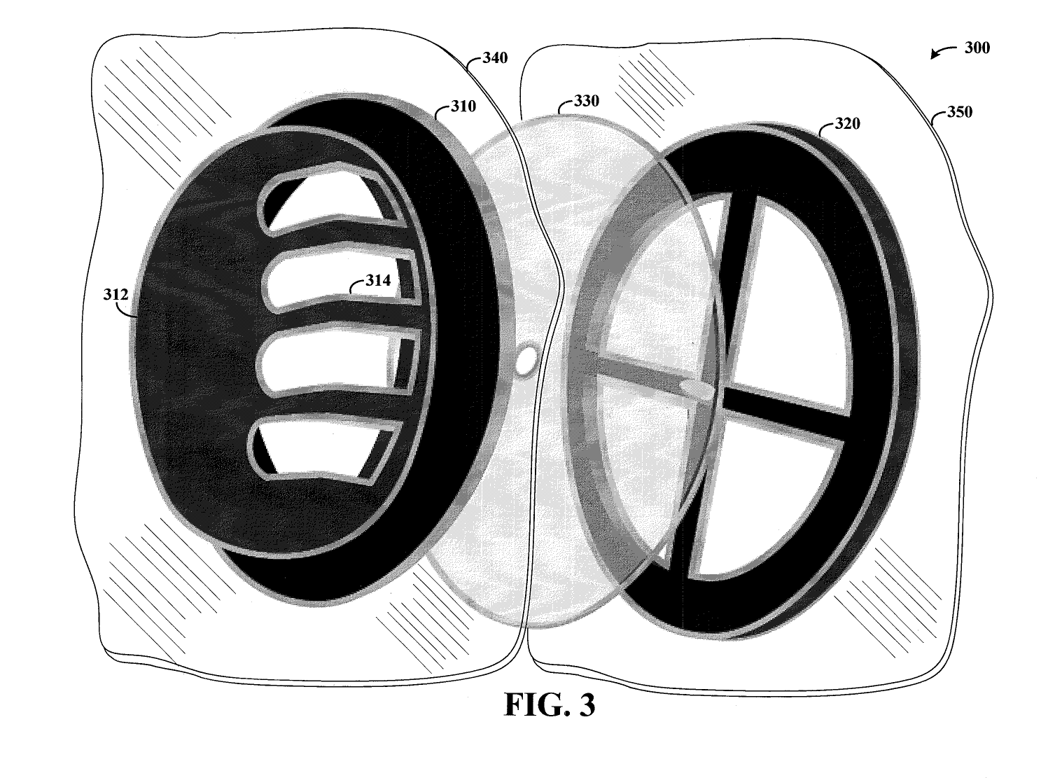

FIG. 3 shows an air valve 300 implemented to pass air through, and secure, an outer shell and filter of a mask, in accordance with another example embodiment of the present invention. The valve 300 has an outer portion 310, an inner portion 320 and a valve diaphragm 330. By way of example, a mask shell 340 and filter 350 are shown in a cut-away type of view, and are coupled with the valve assembly 300 as shown. One or both of the outer portion 310 and inner portion 320 extend through openings in the respective mask shell 340 and filter 350, to couple to one another and secure the shell, filter and diaphragm 330 therebetween.

As shown, the mask shell 340 is between the outer portion 310 and the diaphragm 330, and the filter 350 is between the diaphragm 330 and the inner portion 320. As assembled, the mask shell 340 and filter 350 are pressed together via flanges of the outer and inner valve portions 310 and 320, which also secure the diaphragm 330. The valve 300 may, for example, be implemented with the masks 100 and 200 as shown in FIGS. 1A, 1B and 2, respectively.

In some implementations, outer portion 310 is arranged with the mask shell 340 and filter 350 such that a covered portion 312 faces forward, and an opening portion 314 faces rearward when worn by a user. Accordingly, the covered portion 312 mitigates (e.g., slows down or deflects) the inrush of air into the valve 300 when the user is travelling forward, such as when the user is operating a vehicle in open air. The opening portion 314 facilitates the exhaling of air rearward when the user is travelling forward.

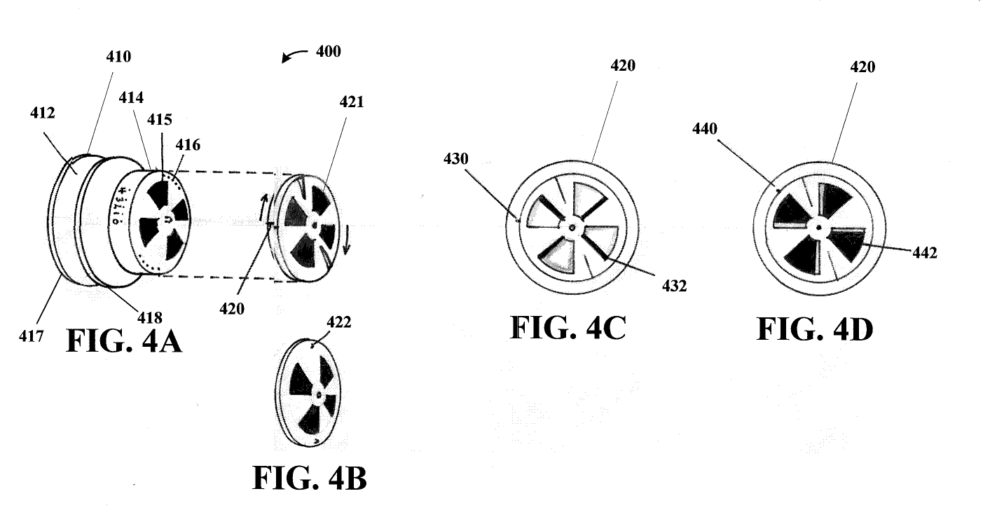

FIGS. 4A-4D show another air valve assembly 400, in accordance with another example embodiment of the present invention. The valve assembly 400 may, for example, be used with a mask such as shown in one or more of FIGS. 1A, 1B, 2 and 3. Referring to FIG. 4A, an outer valve assembly portion 410 includes a region 412 that secures to a mask, and includes a filter/air-flow portion 414 having openings 415 and recesses at 416. A rotatable portion 420 has openings 421 corresponding to the openings 415, and protrusions 422 as shown in an alternate side view in FIG. 4B. The rotatable portion 420 couples to the filter portion 414, and the protrusions 422 lock into the respective recesses 416 to align or offset the respective openings 421 with openings 415, and control air flow through the valve assembly 400.

FIGS. 4C and 4D respectively show the filter assembly 400 at different positions of rotation for the rotatable portion 420, to set air flow through the valve assembly. In FIG. 4C, the rotatable portion 420 is set at a first orientation via protrusion 430, with a small opening 432 for passing air. In FIG. 4D, the rotatable portion 420 is set at a second orientation via protrusion 440, resulting in a larger opening 442 for passing air.

In some embodiments, the region 410 operates to secure a filter to a mask, such as shown in FIG. 3. In one implementation, flanges 417 and 418 couple together to compress and seal a filter to a mask shell.

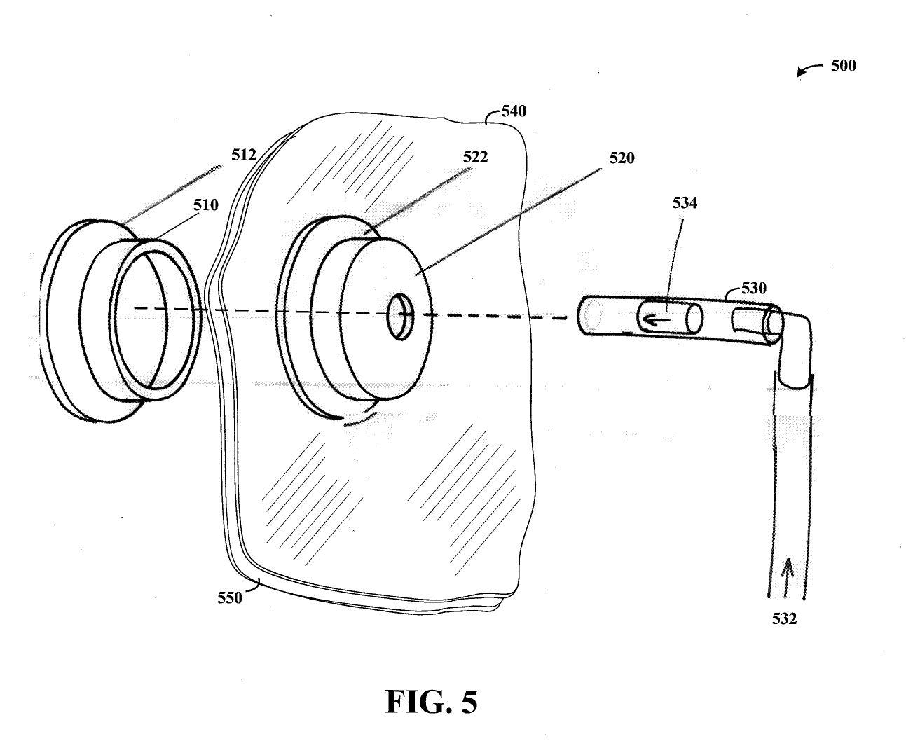

FIG. 5 shows a water supply apparatus 500 for use with a mask shell and filter assembly, in accordance with another example embodiment of the present invention. The water supply apparatus 500 may, for example, be implemented with a filter type arrangement as shown in one or more of FIGS. 1A, 1B, 2 and 3, passing through and securing a filter and mask shell portion. For instance, in one embodiment, one of the valves 112 and 113 as shown in FIGS. 1A and 1B is replaced with the water supply apparatus 500.

The valve apparatus 500 includes inner and outer portions 510 and 520, which respectively have flanges 512 and 522 that secure the apparatus to a mask 540. In some implementations, the flanges 512 and 522 also secure the valve apparatus 500 to a filter 550 and secure the mask and filter to one another. A water supply tube 530 extends through an opening in the outer portion 520, and through the mask 540 and filter 550 for insertion into a user's mouth. A water inlet tube 532 is coupled to a water supply, such as may be carried on a user's back, in an inner pocket or elsewhere. In some embodiments, the water supply tube 530 includes a one-way check valve 534, which prevents flow back out of the water supply tube and into the water inlet tube 532.

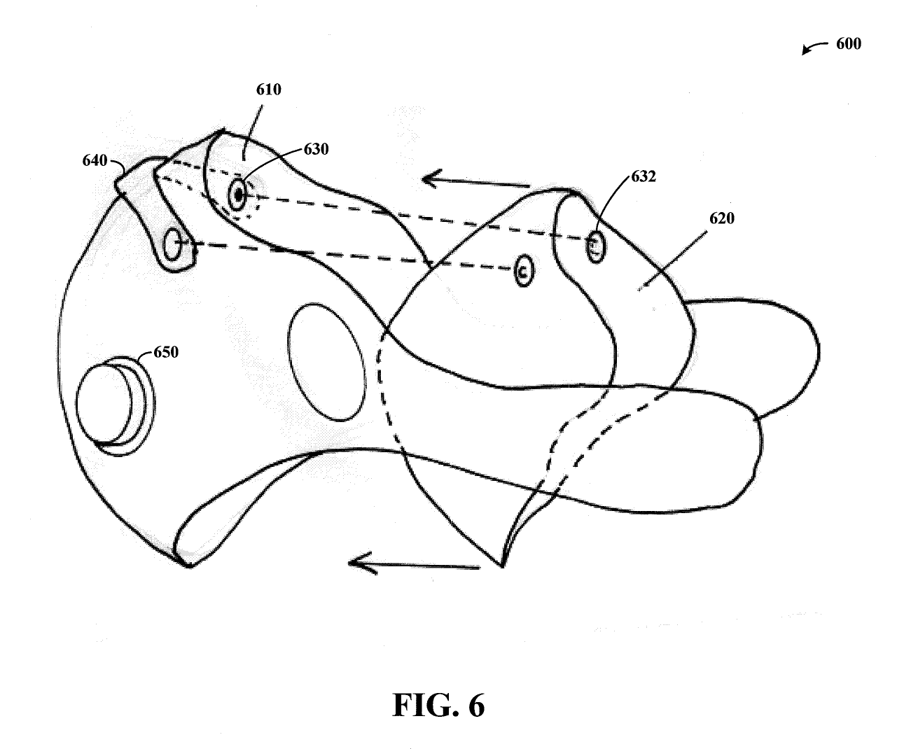

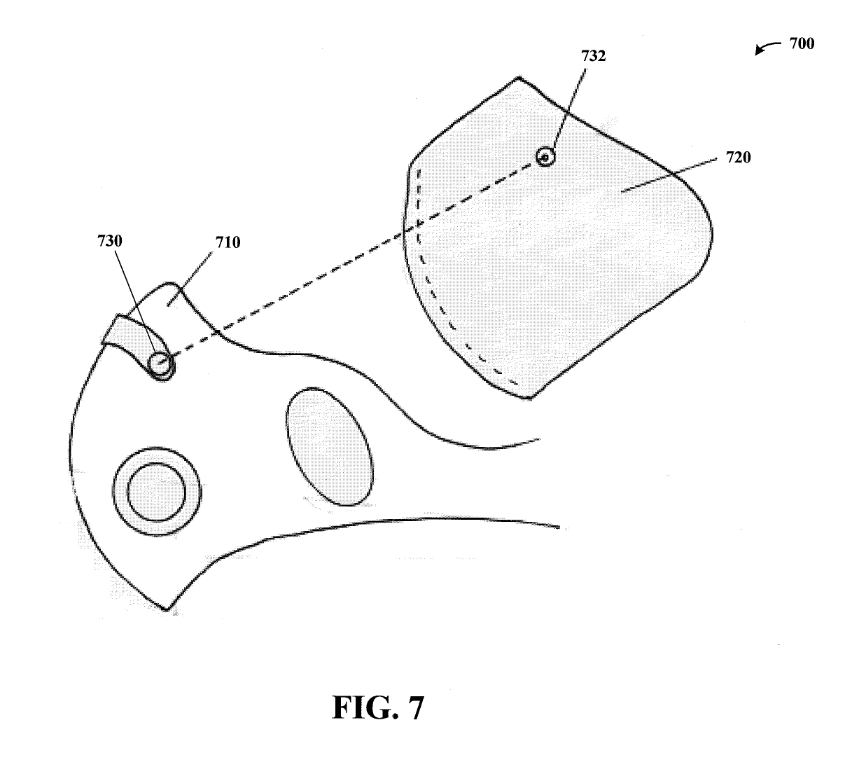

FIGS. 6 and 7 respectively show perspective and side views of face mask arrangement 600 and 700, in accordance with one or more example embodiments. Referring to FIG. 6, a mask shell 610 couples to a filter 620 using fasteners 630 and 632, such as snap-type fasteners. FIG. 7 shows a similar arrangement, with a mask shell 710 being coupled to a filter 720 via fasteners 730 and 732.

Referring back to FIG. 6, the filter 620 is shown coupled to snaps at fasteners that also hold a nose piece 640 to the mask shell 610. The mask arrangement 600 is also shown with a structure 650 that can be implemented with a valve, such as described elsewhere herein or otherwise. In some embodiments, another structure similar to structure 650 is located on an opposite side of the mask arrangement 600. In some implementations, the structure 650 is a valve such as shown in FIGS. 4A-4D. In other implementations, the structure 650 is implemented as a liquid supply component such as shown in FIG. 5. In still other implementations, the structure 650 is a valve such as shown in FIG. 3. In these and other implementations, the structure 650 can also be used to secure the filter 620 to the mask shell 610, such as shown in FIG. 3.

Based upon the above discussion and illustrations, those skilled in the art will readily recognize that various modifications and changes may be made to the present invention without strictly following the exemplary embodiments and applications illustrated and described herein. For example, a variety of different types of materials can be used as a support structure for the mask, and a variety of different types of filters may be used. In addition, various fluid flow valves can be used to suit particular applications. Such modifications do not depart from the true spirit and scope of the present invention, including that set forth in the following claims.

What is claimed is:

1. An apparatus comprising:
a mask shell including
a first material portion configured and arranged with a plurality of openings that pass air through the mask shell, and at least one opening region configured and arranged to accept a valve;
second and third material portions, each one of the second and third portions respectively having a first end connected to opposing sides of the first portion, and a second end configured and arranged with a fastener to couple to the other one of the second and third portions and adjustably and flexibly secure the first portion to a user's face when so coupled;
a filter configured and arranged to filter air, the filter having an opening region therein aligned to the opening region in the first portion of the mask shell and configured and arranged to accept the valve; and
a valve that extends through the respective opening regions in the first portion of the mask shell and in the filter, the valve being configured and arranged to secure the filter to the mask shell at the respective opening regions, and to pass air through the mask shell and the filter at the respective opening regions.

2. The apparatus of claim 1, wherein the valve is configured and arranged to pass air in one direction through the respective opening regions, and to block air from passing in an opposite direction through the respective opening regions.

3. The apparatus of claim 1, wherein the valve includes an inner portion having a flange, and an outer portion having a flange, the inner and outer portions being configured and arranged to couple to one another and secure the filter and the mask shell to one another.

4. The apparatus of claim 1, wherein the valve includes an inner portion having a flange, and an outer portion having a flange, the inner and outer portions being configured and arranged to couple to one another and secure the filter and the mask shell to one another and prevent air from passing through the respective openings at the flanges while passing air in at least one direction through the openings via the valve.

5. The apparatus of claim 1, wherein the first portion includes a rigid nose piece configured and arranged to conform to a user's nose.

6. The apparatus of claim 5, wherein
the first portion includes a first fastener that connects the rigid nose piece to the first portion, and
the filter includes a second fastener that connects the filter to the first fastener.

7. The apparatus of claim 1, wherein the first portion is a non-woven material.

8. The apparatus of claim 1, wherein the first portion includes two portions fastened to one another along a vertical joining region that corresponds to a nose and chin region of a user, the respective portions being configured and arranged to flexibly conform around the user's nose via the vertical joining region.

9. The apparatus of claim 1, wherein the valve is configured and arranged to filter air passing through the valve, from the opening region in the filter to the opening region in the first material portion.

10. The apparatus of claim 1, wherein the first material portion includes a closed cell material configured and arranged to block moisture from passing through the first material portion.

11. The apparatus of claim 1, wherein the first material portion includes
an upper region having a rigid member configured and arranged to conform to a user's nose and support the first material portion thereupon, and
a lower region configured and arranged to wrap around the front and opposing sides of a user's jawbone.

12. The apparatus of claim 1, wherein the second and third material portions are elastic and configured and arranged to elastically secure the first material portion to the user's face.

13. The apparatus of claim 1, wherein the valve includes an outer portion that, when the apparatus is worn by a user, has a covered portion protruding from the first material portion and facing forward, and an opening portion protruding from the first material portion and facing rearward, the covered portion being configured and arranged to mitigate the inrush of air into the valve when the user is travelling forward, the opening portion being configured and arranged to facilitate the exhale of air rearward when the user is travelling forward.

14. The apparatus of claim 1, wherein the filter is configured and arranged with the mask shell to seal to the user's face to about prevent any air passing between the user and an environment without penetrating the filter.

15. The apparatus of claim 1, further including a liquid supply component including first and second portions that secure the water supply component to the filter and the mask shell, and a tube portion that passes through other opening regions in the mask shell and filter to pass liquid through the mask.

16. The apparatus of claim 1, wherein the valve includes a rotatable structure configured and arranged to rotate and set an opening size via which air passes through the valve.

17. An apparatus comprising:
a mask shell configured and arranged to pass air through the mask shell, and to flexibly secure around a user's head;
an air filter configured and arranged with the mask shell to secure to and directly contact the user's face, and to control about all air flow passing between the user and an environment to pass via the filter, with the filter being between the mask shell and the user's face;
a fastener including at least one of
a valve that extends through respective opening regions in the mask shell and the air filter, the valve being configured and arranged to secure the filter to the mask shell at the respective opening regions, and to pass air through the mask shell and the filter at the respective opening regions, and
a fastening structure that connects the air filter to the mask shell.

18. The apparatus of claim 17, wherein the fastener includes both the valve and the fastening structure.

19. The apparatus of claim 17, wherein the fastener includes the valve and the valve is configured and arranged to pass air in one direction through the respective opening regions, and to block air from passing in an opposite direction through the respective opening regions.

20. The apparatus of claim 17, wherein the fastener includes the valve and the valve includes inner and outer portions respectively having first and second flanges that secure the filter to the mask shell.
